(19) United States
(12) Patent Application Publication
(10) Pub. No.: US 2017/0228105 A1
(43) Pub. Date: Aug. 10, 2017

(54) Generation of Media Content for Transmission to a Device

(71) Applicant: Roshan Varadarajan, Santa Clara, CA (US)

(72) Inventor: Roshan Varadarajan, Santa Clara, CA (US)

(21) Appl. No.: 15/424,739

(22) Filed: Feb. 3, 2017

Related U.S. Application Data
(60) Provisional application No. 62/292,109, filed on Feb. 5, 2016.

(51) Int. Cl. G06F 3/0481; G01C 21/34; B60K 35/00

(52) U.S. Cl. CPC G06F 3/0481; B60K 35/00; G01C 21/3484

(57) ABSTRACT

A method can include receiving information associated with an individual. The information can include a destination and data corresponding to a past interaction between the individual and a system associated with a device. The method can further include determining an identity of the individual using the past interaction data when the individual has had a previous interaction with the system. Otherwise, the method can include determining a similar identity of the individual using past interaction data corresponding to another individual and the destination. The method can further include receiving context information. The context information can include: the identity or the similar identity; a time indication; and historical information associated with the identity or the similar identity and the destination. The method can further include generating media content based on the context information, and facilitating communication of the media content between the individual and the device.

### CROSS REFERENCES TO RELATED APPLICATIONS

This application claims the benefit of U.S. Provisional Application No. 62/292,109, filed on Feb. 5, 2016; which is hereby incorporated by reference in its entirety.

### BACKGROUND

Some vehicles include systems for presenting content to a user. For example, a vehicle can include a banner or some other printed material that can convey one or more messages to the user. However, printed material does not change over time; and therefore, can become irrelevant to the user. One solution has been to present digital content to the user in the vehicle. Digital content has the ability to change over time. However, digital content tends to be presented that is independent of the user. For example, digital content can be predetermined without any consideration of the user. In such an example, while the digital content is changing, it might not be relevant to the user. Therefore, there is a need in the art to generate more relevant media content for transmission by a device to a user.

### SUMMARY

Provided are devices, computer-program products, and methods for generating media content for transmission to a device. In some implementations, a device, computer-program product, and method for facilitating communication of media content between an individual and a device can be provided. For example, a method can include receiving information associated with an individual. In some examples, information can include a destination and/or data corresponding to a past interaction between the individual and a system associated with a device. In some implementations, the device might not be associated with the individual. The method can further include determining an identity of the individual using the past interaction data when the individual has had a previous interaction with the system and determining a similar identity of the individual using past interaction data corresponding to another individual and the destination when the individual has not had a previous interaction with the system. The method can further include receiving context information. In some cases, context information can include: the identity or the similar identity, a time indication, and/or historical information associated with the identity or the similar identity and the destination. The method can further include generating media content based on the context information and facilitating communication of the media content to the individual using the device.

In some implementations, the information can further include a current location and/or a third location. The third location can be a location between the current location and the destination. In some implementations, the information can include biographical information associated with the individual, information communicated to the device by a party other than the individual, information gathered by another device disposed in a vehicle, and/or a type of the vehicle.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by embodiments and optional features, modification and variation of the concepts herein disclosed may be resorted to by those skilled in the art, and that such modifications and variations are considered to be within the scope of the systems and methods as defined by the appended claims.

### BRIEF DESCRIPTION OF THE DRAWINGS

Illustrative embodiments are described in detail below with reference to the following figures.

FIG. 1 illustrates an example of an environment for facilitating communication of media content on a device.

FIG. 2 illustrates an example of a generated path from a start to an end.

FIG. 3A illustrates an example of a mechanism that has determined a plurality of entities near a destination.

FIG. 3B illustrates an example of a mechanism for determining an entity among a plurality of entities near a destination based on an entity determination algorithm.

FIG. 4A illustrates an example of a mechanism that has determined a plurality of entities near a point along a path generated from a starting location to a destination.

FIG. 4B illustrates an example of a mechanism for determining an entity among a plurality of entities near a point based on an entity determination algorithm.

FIG. 5 illustrates an example of a device communicating media content based on an entity in a vehicle.

FIG. 6 illustrates an example of a process for facilitating communication of media content on a device.

FIG. 7 illustrates an example of a computer system.

### DETAILED DESCRIPTION

Conventionally, a device, disposed in a vehicle, can communicate media content to an individual. In some examples, the media content might not be associated with the individual. For example, the media content communicated to the individual might not depend on the identity of the individual. Embodiments herein can better determine media content for transmission to a device that presents the media content to the individual. The media content can be based on information received separately from an individual's device. For example, the information can be received by a system that has created a media content model of an individual based on interactions of the system with the individual. In some examples, the media content model can include information associated with the individual that can assist in determining media content to display or play for the individual. In other examples, the media content model can include media content to display or play for the individual.

The device can include a screen that presents the media content. For example, the device can be a television, a tablet, a computer system, or any device capable of presenting dynamic content. The device can be unassociated (sometimes referred to as not associated) with the individual viewing the content and can obtain information through a system that is also unassociated with the individual. In some embodiments, the system can be the device. The system can include information about the individual, such as a destination for a particular trip of the individual. The system can determine the media content based on information received regarding the individual. For example, the system can receive an individual's destination. The system can deliver media content corresponding to other destinations or locations that are in proximity to the individual's destination or location.

In some embodiments, the system can determine information based on the destination. For example, a destination can include a first entity. The system can determine that an individual going to the first entity may want to go to a second entity around the same time. The system, through the device, can then deliver media content related to the second entity.

In some embodiments, the system can extract information about a destination. The extracted information can be used to calculate or determine media content to present to an individual. For example, the system can determine that an endpoint is highly-rated, and can further determine to generate media content corresponding to other endpoints that provide services to other individuals that are associated with the highly-rated endpoint.

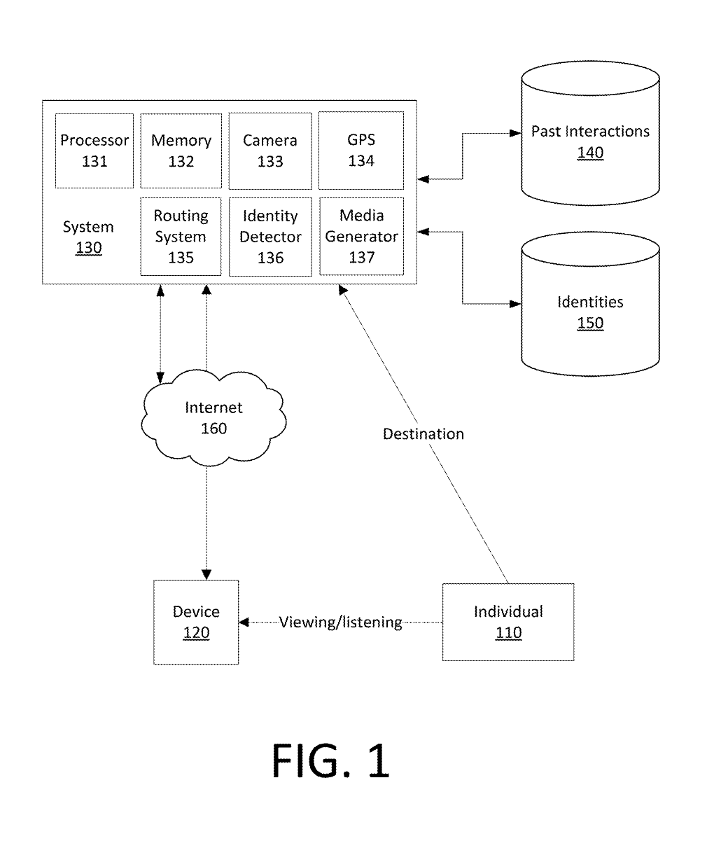

FIG. 1 illustrates an example of an environment for facilitating communication of media content on device 120. The environment can include individual 110, device 120, system 130, past interactions database 140, and identities database 150.

In some embodiments, device 120 can communicate with individual 110. Device 120 can include a processor and a memory. Device 120 can further include a screen, an auditory device, or any other media content delivery mechanism. For example, device 120 can be a screen on the interior of a vehicle. Device 120 can be unowned by individual 110 (e.g., not associated with individual 110). While in some embodiments, associated can mean owned, associated can mean asserting temporary control in other embodiments. For example, a device can be leased to an individual and still be associated with the individual. In some embodiments, device 120 can be owned by system 130 or an individual associated with system 130. In some embodiments, device 120 can be owned by an owner of the vehicle that device 120 is located. In some embodiments, device 120 can be owned by an individual that is not individual 110 and not associated with system 130.

Device 120 can be associated with system 130. In fact, device 120 can be included in system 130. In some embodiments, device 120 can communicate with system 130 using a network. The network can be an Internet connection (e.g., Internet 160). Device 120 can be unassociated with system 130. For example, device 120 can be associated with an entity that is different from an entity associated with system 130. In some embodiments, device 120 can be provided by system 130. In other embodiments, device 120 can be provided by an individual not associated with system 130.

System 130 can include a processor 131 and a memory 132. System 130 can further include camera 133, Global Positioning System (GPS) 134 (or other location determination system), routing system 135, identity detector 136, and media generator 137. A person of ordinary skill in the art will recognize that system 130 can include more or less elements. Elements 132-137 can communicate with processor 131. Elements 132-137 can also include a processor and/or memory of their own. In some examples the system 130 can be a special purpose computer for the purpose of determining an identity of an individual, generating media content based on the identity, and displaying the media content for the individual. In such examples, the system 130 would not be a generic computing device, but rather include the specific elements (or a subset of the specific elements) identified above to provide more relevant media content to display or play.

Camera 133 can be used to take an image, video, or any other representation of an individual to be used to identify an individual using other similar representations. GPS 134 can include a device that can determine a current location of system 130. GPS 134 can include a device that can obtain a current location (or an approximate location) of individual 110 and/or device 120. GPS 134 can also be included in device 120, to determine a location of device 120.

Routing system 135 can determine a path from a first location to a second location. Routing system 135 can be located on system 130, device 120, or remotely from system 130 and device 120. Routing system 135 can be hosted by an entity unassociated with system 130. Routing system 135 can determine directions from a first location to a second location. The directions determined by routing system 135 can be by a number of methods (e.g., walking, driving, public vehicle, air vehicle, water vehicle, or any other method of getting individual 110 from a first location to a second location).

Identity detector 136 can determine an identity of individual 110. The identity can be determined from a communication by individual 110 (directly to the system 130 or indirectly by either intercepting or receiving a communication not meant for the system 130), based on a location of individual 110, by a person other than individual 110, or any other method for identifying an individual. For example, individual 110 can communicate the identity of individual 110 with identity detector 136. Identity detector 136 can also identify individual 110 by using a record associated with individual 110. Identity detector 136 can receive an image from camera 133 to determine an identity of individual 110. Identity detector 136 can include image software that analyzes an image for an identity of individual 110. Identity detector 136 can save the image obtained from camera 133 to identities database 150 for later comparison. Identity detector 136 can also associate an identity of individual 110 with a current location. For example, identity detector 136 can determine an identity is from an address; and therefore, an individual from the address is the identity associated with the address.

Identity detector 136 can also determine a similar identity of individual 110. A similar identity can be an identity of another individual that has at least one characteristic in common with individual 110. A similar identity can also be a general individual that has at least one characteristic in common with individual 110. The general individual can be a combination of identities already accessible by system 130. The general individual can include characteristics that are generally associated with a particular type of individual. In some embodiments, the general individual can be created by referencing Internet 160. By allowing identity detector 136 to use Internet 160, the identity detector can grow a database of identities without having to experience each individual itself. A general identity can also be used when identity detector 136 determines that identity detector 136 either does not have enough or any information associated with an individual. For example, identity detector 136 can require a minimum number of data points about an individual to not use a general identity. In other embodiments, identity detector 136 can require particular data points about an individual to not use a general identity. In such embodiments, identity detector 136 can associate the individual with a general identity of a general individual. The identity of individual 110, identities of other individuals, and all types of general individuals can be saved in a database (e.g., identities database 150). Identities database 150 can be any type of data storage device. Identities database 150 can be a part of system 130 or separate from system 130. Identities database 150 can be located on a remote system (e.g., a cloud system).

Media generator 137 can generate media content to send to device 120 for presenting to individual 110. Media generator 137 can have access to one or more data sources. For example, media generator 137 can have access to identity detector 136 and identities database 150. Media generator 137 can also have access to camera 133, GPS 134, routing system 135, internet 160, and any other source of information that can help determine media content for individual 110. Media generator can receive information from past interactions database 140. Past interactions database 140 can be a database that stores past interactions of individuals with system 130. For example, individual 110 can be using an application associated with system 130. Individual 110 can often use the application associated with system 130. By using information from past interactions database 140, media generator 137 can learn from past interactions using a learning algorithm (e.g., clustering). For example, the media generator 137 can identify a location that the individual 110 frequents. The media generator 137 can also cluster locations that are similar to each other. Based on the clusters, the media generator 137 can identify locations that are clustered together to generate media content regarding.

Past interactions database 140 can include these past interactions with system 130 in a media content model (sometimes referred to as an identity herein) for individual 110. Past interactions database 140 can store information in a number of ways, including by an identity, by an identity characteristic, by an interaction detail, or by any other information that can help media generator 137 use past interactions to determine the media content to generate for individual 110. The identity can be determined through identity detector 136. The identity characteristic can be one or more characteristics of an identity determined through identity detector 136. The interaction detail can be based on any detail of a previous interaction with an individual. For example, the interaction detail can include a current location, a destination, an interaction with system 130 by an individual, an interaction with device 120 by an individual, or any other information that the system has access to that is associated with an individual. In some embodiments, system 130 does not have access to a device associated with individual 110. In such cases, all information about individual 110 can be gathered through other sources that are not directly associated with individual 110.

System 130 can receive a destination from individual 110. The destination can be received through individual 110 sending the destination from a device associated with individual 110 to system 130. The destination can also be received through a record associated with individual 110. System 130 can receive a destination of individual 110 by viewing the record associated with individual 110. The destination can also be received through a person other than individual 110. The person other than the individual 110 can receive a communication of the destination by individual 110 and send the destination to the system 130. For example, the person other than individual 110 can be verbally notified (which can be transcribed using a speech to text system) the destination of individual 110 by individual 110. The person other than individual 110 or system 130 can also be notified of the destination by another system. For example, another system can notify the system 130 that all individuals from a particular address have a particular destination.

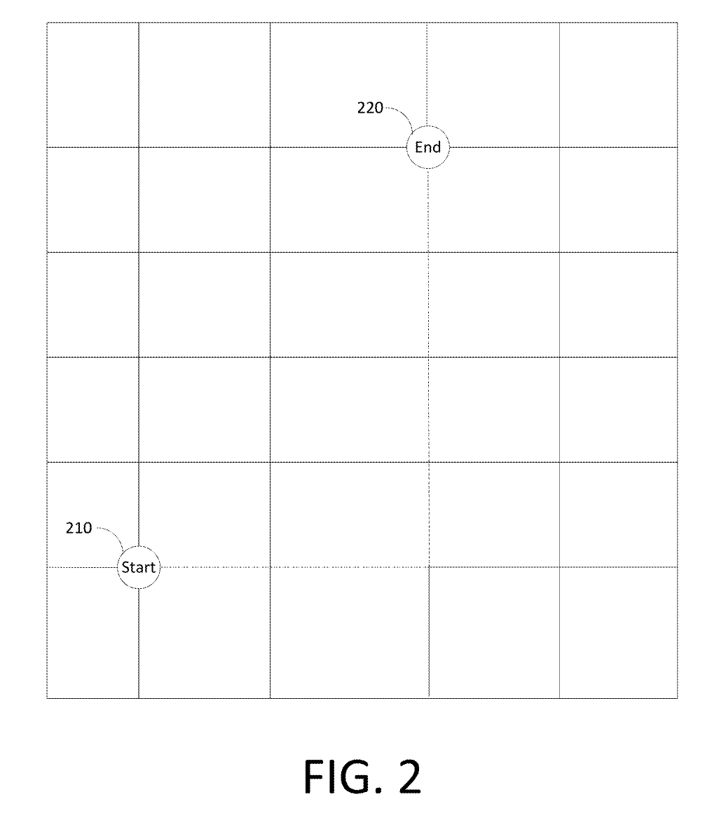

FIG. 2 illustrates an example of a generated path from start 210 to end 220. The generated path is denoted by a dotted line. Start 210 can be a current location, or a starting location. End 220 can be an ending location, or a destination. End 220 can also be a general area. The generated path can be generated through a routing system, such as described for routing system 135. While this disclosure shows a graphic display of the path, a person of ordinary skill in the art will recognize that the path can take many forms, including directions, sets of coordinates, a link to a mapping system, or any other form that can provide a system with a way to get from start 210 to end 220.

The generated path can be based on time to get from start 210 to end 220. The generated path can also be based on the entities that are along the generated path. For example, a particular generated path can pass by an entity that an individual typically stops on the way to end 220. The generated path can choose to take the particular generated path rather than another path, even if the other path is, for another reason, better than the particular generated path. The generated path can be based on one or more other factors that can make a path more favorable over another path for an individual or for a person other than the individual.

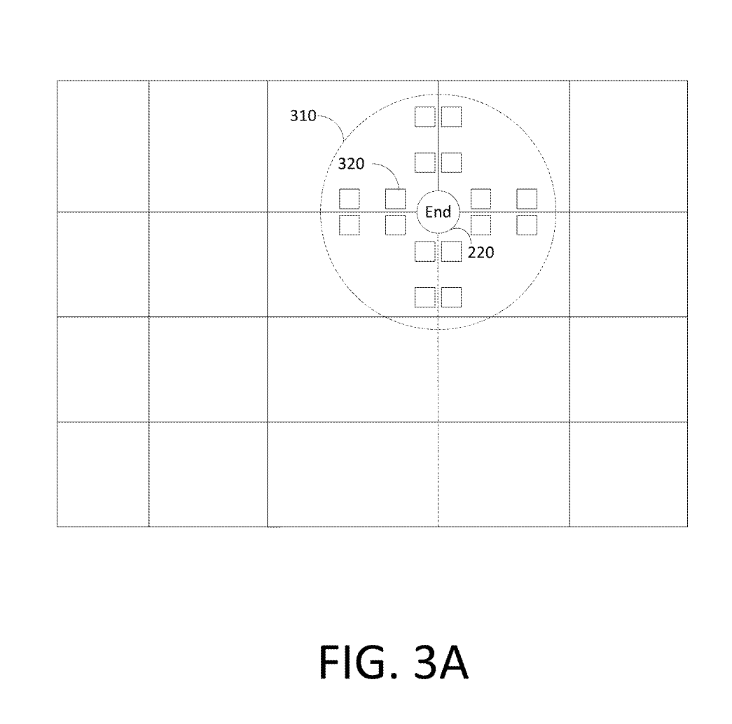

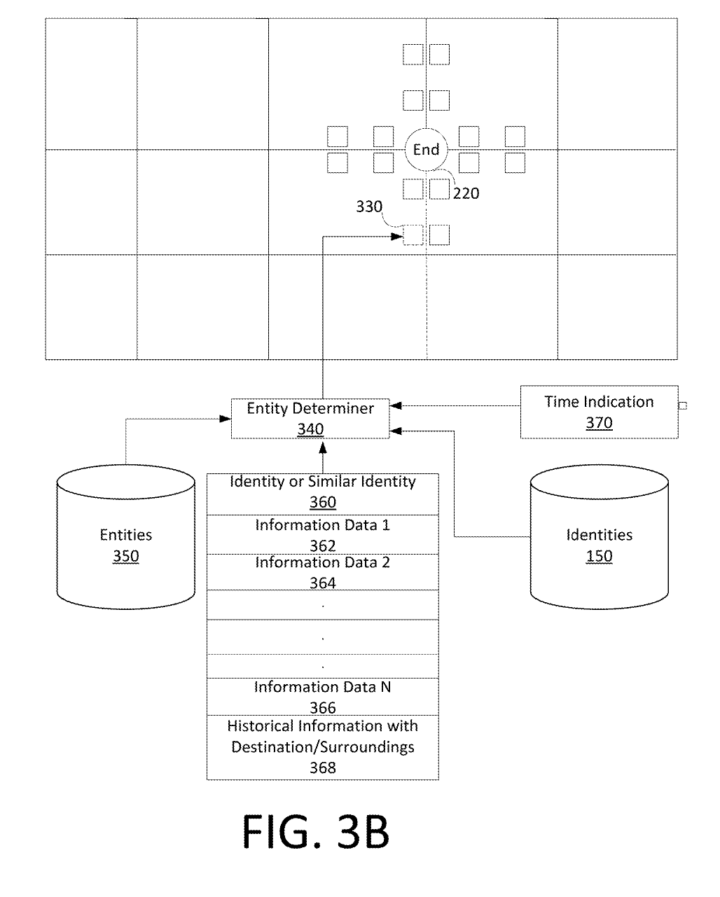

FIG. 3A illustrates an example of a mechanism for determining a plurality of entities near end 220. For readability, only entity 320 is indicated in the figure; however, a person of ordinary skill in the art will recognize that the other boxes are other entities. In addition, while FIG. 3A illustrates entities in area 310, denoted by a dotted line (i.e., near end 220), distance does not have to be a factor in determining an entity of the plurality of entities. In fact, the entities can be determined based one or more of the following factors: distance, past interactions with an individual, degree of association with end 220, degree of association with an individual, rating based on similar identities of an individual, time, or any other factor that can make an entity more relevant to an individual. In addition, the area 310 might not be symmetric (e.g., not a circle). Entity 320 can be public or private. A public entity can include a location available to the public. A private entity can include a location available to a subset of individuals.

FIG. 3B illustrates an example of a mechanism for determining an entity among a plurality of entities near end 220 based on an entity determination algorithm. As discussed for FIG. 3A, the plurality of entities do not need to be within a particular distance from end 220. There are a number of factors that can be assessed to generate the plurality of entities that will then be processed in entity determiner 340, as previously discussed.

In determining entity 330 from the plurality of entities, entity determiner 340 can use a number of inputs, including: entity database 350, identity or similar identity 360 (e.g., information data 1 362, information data 2 364, information data N 366, and historical information with destination/surroundings 368), identities database 150, and time indication 370. Entity database 350 can include the plurality of entities that are currently being processed by entity determiner 340. The plurality of entities that are currently being processed by entity determiner 340 can include end 220. Each entity can include data associated with itself, including characteristics of the entity, review of the entity, size of the entity, hours of the entity, and any other information that can be used to determine an entity from a plurality of entities as more relevant to an individual.

Identity or similar identity 360 can be an identity of an individual that entity determiner 340 is processing. Identity or similar identity 360 can include information data associated with identity or similar identity 360 (e.g., information data 1 362, information data 2 364, and information data N 366). Information data can include characteristics of identity or similar identity 360. The characteristic can be unassociated with, or independent of, end 220. Examples of characteristics can include information about the individual, including age, sex, education, family size, position in family (e.g., father, child, etc.), one or more hobbies, an anxiety level of the individual (measured, for example, by amount of movement in a vehicle using a camera), or any other characteristic that can be associated with an individual.

Other examples of information data can include a plurality of locations. The plurality of locations can include locations that the individual associated with identity or similar identity 360 (e.g., locations identity or similar identity 360) have been before. The plurality of locations can also be associated with other locations that the individual typically pairs with end 220. For example, information data 1 can include an entity with an association of a corresponding entity because the individual typically goes to both at the same time. Information data can also be information on past interactions of an identity with an entity. For example, an entity can include a range of options.

Information data can also include the choice of which option the identity has chosen in the past. For example, an option can include a first rate and a second rate. The information data can include data that identity or similar identity 360 chooses the first rate when going to a particular entity and the second rate when going to all of other entities. In addition, the decision by identity or similar identity 360 on the option can influence other data. For example, if identity or similar identity 360 always chooses the first rate, an information data associated with identity or similar identity 360 can be changed to a higher rate. Information data can also include the number of individuals in a group. For example, if there is information data that identity or similar identity 360 is currently with a plurality of individuals in a group, entity determiner 340 can use this information data to compare identity or similar identity 360 with identities of groups. The identity can also include information based on the frequency that the individual associated with the identities travels on a particular type of vehicle.

Historical information with destination/surroundings 368 can be associated with the identity or the similar identity 360 and the destination. Historical information with destination/surroundings 368 can include past interaction data from past interactions database 140, data associated with at least one characteristic of the identity or the similar identity, or any other information that can be accessed by the system about identity or the similar identity 360. In some embodiments, historical information with destination/surroundings 368 can be received independently, or separately, from a device associated with the individual, as previously discussed.

Identities database 150 can include information as previously mentioned. Each identity in identities database 150 can include information similar to identity or similar identity 360 or any other identity in identities database 150. Each identity can include different information from each other and can be in a different structure from each other. The plurality of identities that are used as inputs to entity determiner 340 can include all or a subset of the identities in identities database 150. The subset of identities can be determined by comparing for similarity of each identity in identities database 150 with identity or similar identity 360. The comparison can include comparing at least one characteristic of each identity of identities database 150 with identity or similar identity 360.

In some embodiments, time indication 370 can be either a current time or an estimated time of arrival at the destination. In other embodiments, the time indication is not an input to entity determiner 340 because entity determiner 340 already knows the necessary time.

After the entity is determined from the plurality of entities, media content can be generated. Generation of media content can include determining a form of communication for the media content. In determining the form, system 130 can identify one or more devices that can communicate with the individual. For example, the system 130 can be connected to one or more visual devices and one or more audio devices that can communication with an individual. Once the one or more devices are identified, system 130 can either proceed with the one or more devices as options, or determine a subset of the one more devices. The subset of the one or more devices can be determined based on current availability of the devices. For example, a device can be eliminated when it is already communicating media content to the individual.

Generation of media content can further include determining media content associated with the entity from the plurality of entities. The media content that will be presented to an individual at a current time can be associated with a current time or a future time. The media content can depend on the one or more forms of communication identified. In some embodiments, the media content can be determined by inquiring the entity determined or by determining from a plurality of media content associated with the entity. The determination of media content can be similar to the determination of the entity. The determination of media content can be based on identity or similar identity 360, time indication 370, identities database 150, and any other information that can tend to make media content more relevant to an individual. In some examples, the determination of media content can be based on a learning algorithm that identifies media content that is most similar to a location that an individual is heading. In such examples, the learning algorithm can be clustering, which can identify a group of media content that is most similar to the location. Among the group of media content, one or more can be selected.

In some embodiments, an individual can interact with device 120. By interacting with device 120, identity or similar identity 360 associated with the individual can be updated to reflect the individual's preferences. An interaction can include direct manipulation of device 120 by the individual. For example, an individual can communicate to learn more about a particular entity. Such an interaction can notify system 130 that the individual is interested in the entity. An interaction can also include indirect manipulation of device 120 by the individual (e.g., the individual verbally communicating with another individual to change or turn off device 120). An interaction can also include the lack of an interaction of device 120 by the individual. Through interactions, system 130 can implement a learning algorithm (e.g., clustering) to update identity or similar identity 360. For example, the learning algorithm can suggest media content to generate for the individual. In some embodiments, the learning algorithm can compare the data from the individual with other individuals. MORE

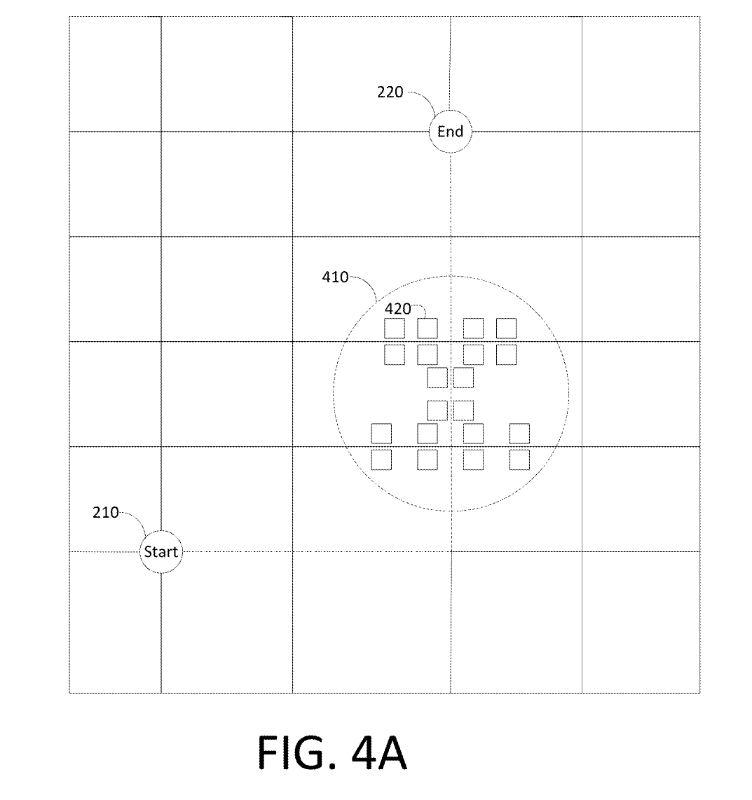

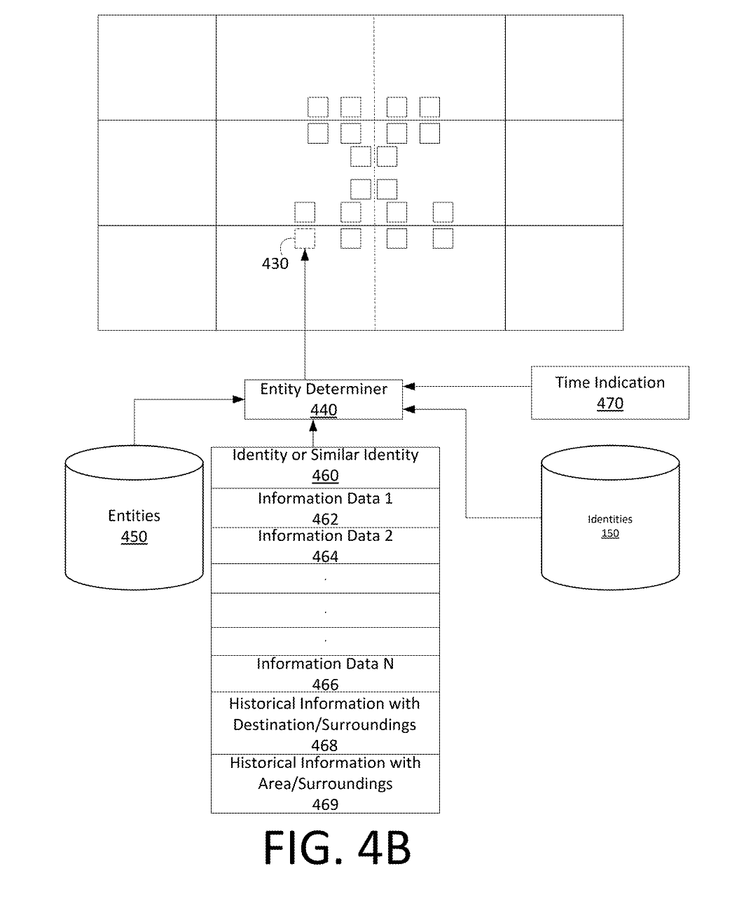

FIG. 4A illustrates an example of a mechanism for determining a plurality of entities near a point along a path generated from start 210 to end 220. Again, for readability, only entity 420 is indicated in the figure; however, a person of ordinary skill in the art will recognize the other boxes are other entities. In addition, while FIG. 4A illustrates entities in area 410, denoted by a dotted line, distance does not have to be a factor in generating the plurality of entities. In fact, the entities can be chosen based on other factors, including distance, past interactions with an individual, degree of association with the point along the generated path, degree of association with an individual, popularity based on similar identities of an individual, time, or any other factor that can make an entity more relevant to an individual. Entity 420 can be public or private.

FIG. 4B illustrates an example of a mechanism for choosing entity 430 among a plurality of entities near a point based on an entity determination algorithm. Here, the entity determination algorithm can be performed by entity determiner 440, which can be substantially similar to the entity determiner 340. In fact, the entity determiner 340 can simply be reused for entity determiner 440, except that the inputs can be different. In particular, rather than searching for entities associated with end 220, entity determiner 440 can search for entities associated with end 220 and/or the point. In addition, because the location has changed, identity or similar identity 460 can include more information than identity or similar identity 360. Identity or similar identity 460 can include historical information with the point and the surrounding area of the point (e.g., historical information with area/surroundings 469). The same steps for generating media content and interacting with a device, as described in FIG. 3B, can be involved after choosing entity 430.

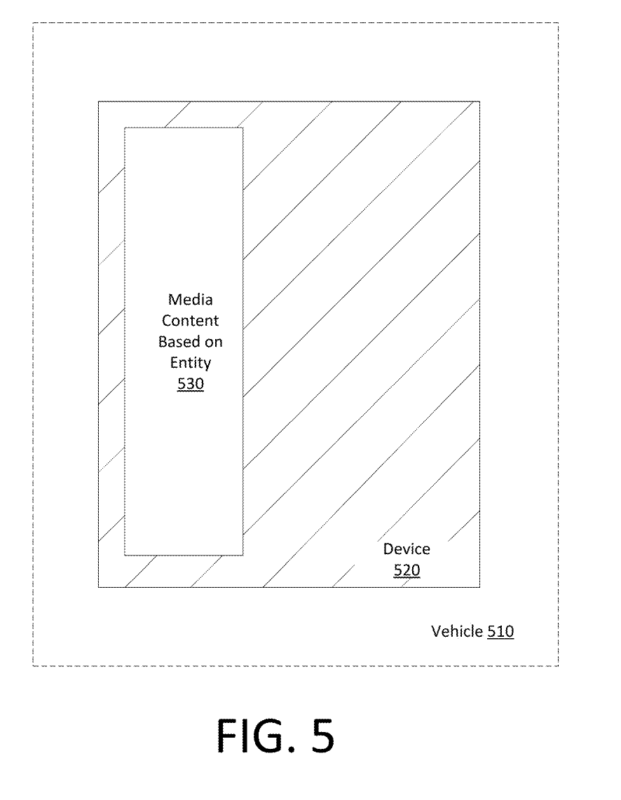

FIG. 5 illustrates an example of device 520 presenting media content based on entity 530 in vehicle 510. Device 520 can be a display device, a sound-producing device, or any other device capable of presenting information to an individual. Examples of a display device can include a television or a tablet.

Media content based on entity 530 can be visual or auditory information that is based on the entity determined by entity determiner 340 or entity determiner 440. The media content can be determined by entity determined. For example, the entity determined can provide media content to be used for the individual. The media content can also be determined by determining the most relevant media content from a plurality of media content associated with an entity, similarly to determining an entity. For example, media content can include a preview of a first item, a second item, and a third item from a first entity at the destination of an individual. The media content associated with the first item can be determined based on the location and the time. Media content can also be a combination of information. For example, media content can include a first item from a first entity and a second item from a second entity where the first entity is not associated with the second entity. In addition, media content can be overlaid on other content, as shown in FIG. 5. For example, device 520 can be presenting a first item associated with the destination. Media content based on entity 530 can communicate, as an overlay, information associated with a second entity because the second entity is near an entity associated with the first item. On the other hand, the media content can be the main focus of device 520, and other information can be communicated as an overlay. For example, a first item can be presented on device 520 while an overlay of second item is in a corner of device 520.

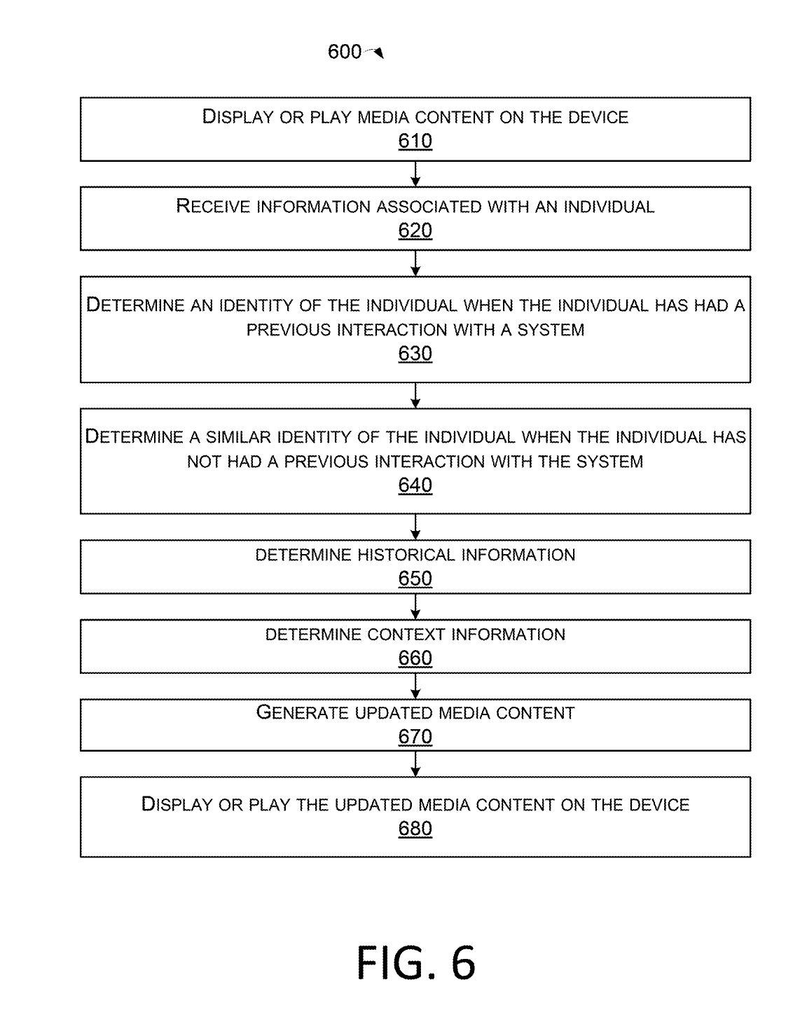

Various example implementations of the above-described examples can be provided. FIG. 6 illustrates an example of process 600 for facilitating communication of media content on a device. In some aspects, process 600 can be performed by a computing device, such as system 130 described in FIG. 1. While specific examples can be given of a system performing process 600, one of ordinary skill in the art will appreciate that other devices or programs may perform process 600.

Process 600 is illustrated as a logical flow diagram, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 600 can be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a machine-readable storage medium, for example, in the form of a computer program comprising a plurality of instructions executable by one or more processors. The machine-readable storage medium may be non-transitory.

At step 610, process 600 can include displaying or playing media content on the device. In some examples the media content can be visual or audio content. For example, an image or a video can be on the device. For another example, a song can be playing. In some examples, the media content displaying or playing on the device can be unassociated with the individual.

At step 620, the process 600 can further include receiving information associated with an individual. The information can include a destination. The information can further include data corresponding to a past interaction between the individual and a system associated with the device. The information can be received independently, or separately, from a device associated with the individual. For example, while a device associated with the individual can send a destination to a system, the system can save the destination and provide the destination to a storage system on the system. Another way that the information can be received independent from a device associated with the individual is by the individual verbally speaking a destination for the individual (e.g., using a speech to text system). In such an example, the information can be received independently of a device associated with the individual.

At step 630, process 600 can also include determining an identity of the individual when the individual has had a previous interaction with the system. In some examples, determining the identity can include using the past interaction data. Determining whether the individual has past interaction data can include analyzing a form of communication that the individual is using to contact the system. For example, the individual can contact the system through a phone number, application on a phone, or any other method of communicating with the system that the individual requires their services. Through a contact with the system, the system can identify the individual as a prior individual who interacted with the system at a prior point in time. Another method for identifying an individual is with the use of image and/or voice recognition. The system can include a camera, e.g. camera 133. The camera can take an image of individuals. When an individual comes into contact with the system, the system can take an image of the individual and compare the image of the individual with an image in an identity of an individual.

At step 640, if the individual has not had a previous interaction with the system, process 600 can also include determining a similar identity of the individual using past interaction data corresponding to another individual and the destination. The other individual can be either an individual that the system has interacted with before or a general individual, as previously discussed.

At step 650, the process 600 can further include determining historical information. In some examples, the historical information can be associated with the destination and/or either the identity or the similar identity. In some examples, historical information associated with the identity or the similar identity can include past interaction data, data associated with at least one characteristic of the identity or the similar identity, or any other information that is accessed by the system about the identity or the similar identity. In some examples, the historical information can be received by searching publically available information for information regarding the identity or the similar identity (below, the identity can refer to the identity or the similar identity). For example, a name associated with the identity can be identified. The name can then be searched using the publically available information. For example, an account on a social media website that is associated with the identity can be identified. From the social media website, past locations of the identity, interests of the identity, friends of the identity, and other information provided by a social media website can be identified.

At step 660, process 600 can also include determining context information. The context information can include at least one of the identity, the similar identity, a time indication, and historical information associated with the identity or the similar identity and the destination. In some embodiments, the time indication can either be a current time or an estimated time of arrival at the destination. In other embodiments, the time can be already accessible by the system. In some embodiments, context information, in particular historical information, can be received independently, or separately, from a device associated with the individual, as previously discussed.

In some examples, the process 600 can further include determining updated media content to display or play. In such examples, the updated media content can be based on the context information. For example, a list can be generated with possible media content (e.g., one or more media content). In some examples, the list can be generated by identifying past locations that the identity is associated with. In such examples, the list can include media content associated with the past locations. In other examples, the list can be generated by identifying one or more interests or hobbies of the identity. In such examples, the list can include media content associated with the one or more interests or hobbies. In some examples, an individual can select media content to be displayed or played from the list.

In other examples, media content from the list can be automatically identified and served to the individual without any interaction by the individual. For example, the media content can be randomly selected from the list. For another example, each item (e.g., media content) from the list can be associated with a value that represents a relevance of the media content to the identity. In some examples, the value can be computed by summing up a number of references in the context information to a topic that the media content is associated with, a proximity to the destination, or any combination thereof. In some examples, the value can be computed based on a learning algorithm that clusters attributes of the identity with particular media content. For example, if an identity includes an attribute such as sporty, media content associated with sports can receive a higher value. Of course, it should be recognized that the identity can include a plurality of attributes, each attribute being associated with a different weight.

In some examples, determining the updated media content can include identifying an entity among a plurality of entities (as previously discussed), determining a form of communication for the media content (as previously discussed), and determining media content associated with the entity (as previously discussed). To reiterate the subjects previously discussed, the determination of the entity can be based on the destination. In addition, the determination of media content associated with the entity can be similar to determining an entity.

At step 670, process 600 can also include generating updated media content based on the context information. Then, at step 680, process 600 can also include displaying or playing the updated media content on the device.

In some examples, the process 600 can also include receiving an interaction with the device. In some examples, the interaction can be by the individual, as previously discussed. In other examples, the interaction can be by a second individual in the vehicle. In other examples, the interaction can be by an individual or a system remote from the vehicle. The process 600 can also include updating the media content based on the interaction. For example, the interaction can request information based on the media content. In response, the device can change the media content to respond to the request.

The process 600 can also include updating the context information based on the interaction. For example, the identity or similar identity can be updated after an interaction in order to generate media content based on the interaction in the future.

The process 600 can also include sending, to an entity, a message based on the interaction. In some embodiments, the entity can be associated with the media content. The entity can also be associated with the destination. In some embodiments, the entity can be associated with the device. The entity can also be associated with the system. In other embodiments, the entity can be the individual. In some embodiments, the message can include notification that the interaction occurred.

In some examples, the process 600 can further include determining a time and a location. In such examples, the location can be a start of a route to the destination (e.g., a current location at the beginning of the route) (as described in FIG. 2). In some examples, the process 600 can further include determining a second destination that is (1) between the start and the destination or (2) associated with the start. In such examples, the second destination can be determined based on the identity. For example, the identity can include one or more previous destinations. In such an example, the second destination can be one of the one or more previous destinations. In some examples, the second destination can be one of the one or more previous destinations that was a destination for the start at a previous time.

In some examples, the process 600 can further include adding the second destination to the route for the individual. For example, the second destination can be added to the route to the destination such that the route stops at the second destination and then the destination. In some examples, media content can suggest the second destination to the individual such that the individual can accept or deny the suggestion to add the second destination to the route.

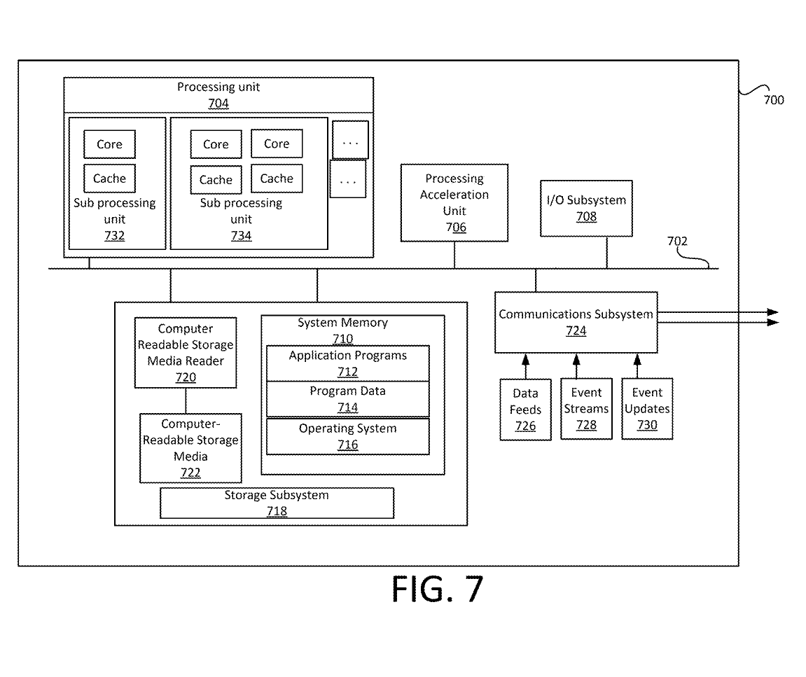

FIG. 7 illustrates an example of a computer system 700, in which various examples of the present disclosure may be implemented. The computer system 700 may be used to implement any of the computer systems described above. As shown in the figure, computer system 700 includes a processing unit 704 that communicates with a number of peripheral subsystems via a bus subsystem 702. These peripheral subsystems may include a processing acceleration unit 706, an I/O subsystem 708, a storage subsystem 718, and a communications subsystem 724. Storage subsystem 718 includes tangible computer-readable storage media 722 and a system memory 710.

Bus subsystem 702 provides a mechanism for letting the various components and subsystems of computer system 700 communicate with each other as intended. Although bus subsystem 702 is shown schematically as a single bus, alternative examples of the bus subsystem may utilize multiple buses. Bus subsystem 702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 704, which can be implemented as one or more integrated circuits (e.g., a conventional microprocessor or microcontroller), controls the operation of computer system 700. One or more processors may be included in processing unit 704. These processors may include single core or multicore processors. In certain examples, processing unit 704 may be implemented as one or more independent processing units 732 and/or 734 with single or multicore processors included in each processing unit. In other examples, processing unit 704 may also be implemented as a quad-core processing unit formed by integrating two dual-core processors into a single chip.

In various examples, processing unit 704 can execute a variety of programs in response to program code and can maintain multiple concurrently executing programs or processes. At any given time, some or all of the program code to be executed can be resident in processor(s) 704 and/or in storage subsystem 718. Through suitable programming, processor(s) 904 can provide various functionalities described above. Computer system 700 may additionally include a processing acceleration unit 706, which can include a digital signal processor (DSP), a special-purpose processor, and/or the like.

I/O subsystem 708 may include user interface input devices and user interface output devices. User interface input devices may include a keyboard, pointing devices such as a mouse or trackball, a touchpad or touchscreen incorporated into a display, a scroll wheel, a click wheel, a dial, a button, a switch, a keypad, audio input devices with voice command recognition systems, microphones, and other types of input devices (including other types of input devices described above). User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three-dimensional (3D) mice, joysticks or pointing sticks, game pads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 700 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 700 may comprise a storage subsystem 718 that comprises software elements, shown as being currently located within a system memory 710. System memory 710 may store program instructions that are loadable and executable on processing unit 704, as well as data generated during the execution of these programs.

Depending on the configuration and type of computer system 700, system memory 710 may be volatile (such as random access memory (RAM)) and/or non-volatile (such as read-only memory (ROM), flash memory, etc.). The RAM typically contains data and/or program modules that are immediately accessible to and/or presently being operated and executed by processing unit 904. In some implementations, system memory 710 may include multiple different types of memory, such as static random access memory (SRAM) or dynamic random access memory (DRAM). In some implementations, a basic input/output system (BIOS), containing the basic routines that help to transfer information between elements within computer system 700, such as during start-up, may typically be stored in the ROM. By way of example, and not limitation, system memory 710 also illustrates application programs 712, which may include client applications, Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 718 may also provide a tangible computer-readable storage medium for storing the basic programming and data constructs that provide the functionality of some examples. Software (programs, code modules, instructions) that when executed by a processor provide the functionality described above may be stored in storage subsystem 718. These software modules or instructions may be executed by processing unit 704. Storage subsystem 718 may also provide a repository for storing data used in accordance with the present invention.

Storage subsystem 718 may also include a computer-readable storage media reader 720 that can further be connected to computer-readable storage media 722. Together and, optionally, in combination with system memory 710, computer-readable storage media 722 may comprehensively represent remote, local, fixed, and/or removable storage devices plus storage media for temporarily and/or more permanently containing, storing, transmitting, and retrieving computer-readable information.

Computer-readable storage media 722 containing code, or portions of code, can also include any appropriate media known or used in the art, including storage media and communication media, such as but not limited to, volatile and non-volatile, removable and non-removable media implemented in any method or technology for storage and/or transmission of information. This can include tangible, non-transitory computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. When specified, this can also include nontangible, transitory computer-readable media, such as data signals, data transmissions, or any other medium which can be used to transmit the desired information and which can be accessed by computing system 900.

By way of example, computer-readable storage media 722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 700.

Communications subsystem 724 provides an interface to other computer systems and networks. Communications subsystem 724 serves as an interface for receiving data from and transmitting data to other systems from computer system 700. For example, communications subsystem 924 may enable computer system 700 to connect to one or more devices via the Internet. In some examples communications subsystem 724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some examples communications subsystem 724 can provide wired network connectivity (e.g., Ethernet) in addition to or instead of a wireless interface.

In some examples, communications subsystem 724 may also receive input communication in the form of structured and/or unstructured data feeds 726, event streams 728, event updates 730, and the like on behalf of one or more users who may use computer system 700.

By way of example, communications subsystem 724 may be configured to receive data feeds 926 in real-time from users of social media networks and/or other communication services such as Twitter® feeds, Facebook® updates, web feeds such as Rich Site Summary (RSS) feeds, and/or real-time updates from one or more third-party information sources.

Additionally, communications subsystem 724 may also be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 724 may also be configured to output the structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various examples.

A number of embodiments of the disclosure have been described. Nevertheless, it will be understood that various modification may be made without departing from the scope of the disclosure.

What is claimed is:

1. A computer-implemented method for facilitating communication of media content on a device, the method comprising:
displaying or playing media content on the device;
receiving information associated with an individual, wherein the information includes a destination and data corresponding to a past interaction between the individual and a system associated with the device, and wherein the device is not associated with the individual;
determining an identity of the individual when the individual has had a previous interaction with the system, wherein determining an identity includes using the past interaction data;
determining a similar identity of the individual when the individual has not had a previous interaction with the system, wherein determining a similar identity includes using past interaction data corresponding to another individual and the destination;
determining historical information, wherein historical information is associated with the destination and either the identity or the similar identity;
determining context information, wherein the context information includes, historical information and information associated with the identity or the similar identity;
generating updated media content, wherein the updated media content is generated using the context information; and
displaying or playing the updated media content on the device.

2. The method of claim 1, wherein the information associated with the individual further includes a current location.

3. The method of claim 1, wherein the information associated with the individual further includes a third location, and wherein the third location is a location between the current location and the destination.

4. The method of claim 1, wherein the information associated with the individual includes at least one of: biographical information, information communicated to the device by a second individual, information gathered by another device disposed in a vehicle, and a type of vehicle.

5. The method of claim 1, further comprising:
receiving an interaction with the device; and
updating the media content based on the interaction.

6. The method of claim 5, further comprising:
updating the context information based on the interaction.

7. The method of claim 5, further comprising:
sending, to an entity, a message based on the interaction.

8. The method of claim 7, wherein the entity is associated with the media content.

9. The method of claim 7, wherein the entity is associated with the destination.

10. The method of claim 7, wherein the entity is associated with the device.

11. The method of claim 7, wherein the entity is associated with the system.

12. The method of claim 7, wherein the entity is the individual.

13. The method of claim 1, wherein the context information further includes a time.

14. A system for facilitating communication of media content on a device, the system comprising:
one or more processors; and
a non-transitory computer-readable medium containing instructions that, when executed by the one or more processors, cause the one or more processors to perform operations including:
receive information associated with an individual, wherein the information includes a destination and data corresponding to a past interaction between the individual and a system associated with the device, and wherein the device is not associated with the individual;
determine an identity of the individual using the past interaction data when the individual has had a previous interaction with the system;
determine a similar identity of the individual using past interaction data corresponding to another individual and the destination when the individual has not had a previous interaction with the system;
receive context information, wherein the context information includes a time indication, historical information, and information associated with the identity or the similar identity; and wherein the historical information is associated with the destination and either the identity or the similar identity;
generate media content based on the context information; and
facilitate communication of the media content between the individual and the device.

15. The system of claim 14, further comprising instructions that, when executed by the one or more processors, cause the one or more processors to perform operations including:
receive an interaction with the device; and
update the media content based on the interaction.

16. The system of claim 15, further comprising instructions that, when executed by the one or more processors, cause the one or more processors to perform operations including:
updating the context information based on the interaction.

17. The system of claim 15, further comprising instructions that, when executed by the one or more processors, cause the one or more processors to perform operations including:
sending, to an entity, a message based on the interaction.

18. A computer-program product tangibly embodied in a non-transitory machine-readable storage medium, including instructions that, when executed by the one or more processors, cause the one or more processors to:
receive information associated with an individual, wherein the information includes a destination and data corresponding to a past interaction between the individual and a system associated with the device, and wherein the device is not associated with the individual;
determine an identity of the individual using the past interaction data when the individual has had a previous interaction with the system;
determine a similar identity of the individual using past interaction data corresponding to another individual and the destination when the individual has not had a previous interaction with the system;
receive context information, wherein the context information includes a time indication, historical information, and information associated with the identity or the similar identity; and wherein the historical information is associated with the destination and either the identity or the similar identity;
generate media content based on the context information; and
facilitate communication of the media content between the individual and the device.

19. The computer-program product of claim 18, further including instructions that, when executed by the one or more processors, cause the one or more processors to:
receive an interaction with the device; and
updating the media content based on the interaction.

20. The computer-program product of claim 19, further including instructions that, when executed by the one or more processors, cause the one or more processors to:
update the context information based on the interaction.
